(19) United States
(12) Patent Application Publication
(10) Pub. No.: US 2026/0246174 A1
(43) Pub. Date: Aug. 20, 2026

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shuhei TERADA, Osaka (JP); Kota MATSUO, Osaka (JP); Kazuya KOBAYASHI, Mie (JP); Yusuke ITO, Mie (JP); Kaisei HAZEMOTO, Mie (JP)

(21) Appl. No.: 19/161,313

(22) PCT Filed: Feb. 19, 2024
(86) PCT No.: PCT/JP2024/005732

§ 371 Date: Sep. 2, 2025

(30) Foreign Application Priority Data
Mar. 10, 2023 (JP) 2023-037105

(51) Int. Cl. H01R 12/71; H01R 13/50; H01R 13/652

(52) U.S. Cl. CPC H01R 12/712; H01R 13/50; H01R 13/652

(57) ABSTRACT

A connector (10, 10A) comprises: an outer conductor (12, 13); an inner conductor (11) arranged on the inside of the outer conductor (12, 13); and a dielectric body (14) interposed between the inner conductor (11) and the outer conductor (12, 13). The outer conductor (12, 13) includes: a bottom surface (46) that opposes a board surface of a circuit substrate (100); a lead-out port (42) that opens in the bottom surface (46) and leads the inner conductor (11) out toward the circuit substrate (100) side; mounting parts (47, 48) that are provided protruding from the bottom surface (46); and substrate installation parts (51, 52), at least one each thereof being provided protruding at each of two sides of the bottom surface (46) that sandwich a mounting area (49) in which the mounting part (47, 48) and the lead-out port (42) are formed, and a distal end surface thereof being positioned more toward the distal side than a distal end surface of the mounting part (47, 48).

### TECHNICAL FIELD

The present disclosure relates to a connector.

### BACKGROUND

A connector disclosed in Patent Document 1 is provided with a plug body (hereinafter, referred to as an outer conductor) and an inner conductive portion (hereinafter, referred to as an inner conductor) arranged inside the plug body. The outer conductor has a bottom surface facing a board surface of a circuit board. A mounting portion to be electrically connected to a ground electrically conductive path of the circuit board is provided on the bottom surface of the outer conductor. The inner conductor is passed through the bottom surface of the plug body and a lower end part thereof is electrically connected to a signal electrically conductive path of the circuit board.

### PRIOR ART DOCUMENT

### Patent Document

Patent Document 1: JP 2019-071272 A

### SUMMARY OF THE INVENTION

### Problems to be Solved

The mounting portion of the outer conductor is soldered and connected to a copper foil (electrically conductive layer) of the circuit board. For example, if the tip surface of the mounting portion is shifted in position with respect to the circuit board during reflow soldering, there is a concern that a properly solder-connected state cannot be obtained, such as due to the contact of the mounting portion with a resist (insulation layer, resin layer) of the circuit board.

Accordingly, the present disclosure aims to provide a connector capable of improving mountability on a circuit board.

### Means to Solve the Problem

The present disclosure is directed to a connector with an electrically conductive outer conductor, an electrically conductive inner conductor to be arranged inside the outer conductor, and an insulating dielectric interposed between the inner conductor and the outer conductor, the outer conductor including a bottom surface facing a board surface of a circuit board, a pull-out opening open in the bottom surface, the inner conductor being pulled out toward the circuit board through the pull-out opening, a mounting portion provided to project on the board surface, and board installing portions, at least one board installing portion being provided to project on each of both sides across a mounting area on the bottom surface, the mounting portion and the pull-out opening being formed in the mounting area, tip surfaces of the board installing portions being located further than a tip surface of the mounting portion.

### Effect of the Invention

According to the present disclosure, it is possible to provide a connector capable of improving mountability on a circuit board.

### BRIEF DESCRIPTION OF THE DRAWINGS

FIG. 1 is a side view in section of a connector in a first embodiment of the present disclosure.

FIG. 2 is a perspective view of a second outer conductor shown in FIG. 1.

FIG. 3 is a perspective view of a first outer conductor shown in FIG. 1.

FIG. 4 is a bottom view of the first outer conductor shown in FIG. 1.

FIG. 5 is a bottom view of the connector shown in FIG. 1.

FIG. 6 is a side view in section enlargedly showing a part of the connector shown in FIG. 1 to be mounted on a circuit board.

FIG. 7 is a bottom view of a connector in a second embodiment of the present disclosure.

### DETAILED DESCRIPTION TO EXECUTE THE INVENTION

### [Description of Embodiments of Present Disclosure]

First, embodiments of the present disclosure are listed and described.

(1) The connector of the present disclosure is provided with an electrically conductive outer conductor, an electrically conductive inner conductor to be arranged inside the outer conductor, and an insulating dielectric interposed between the inner conductor and the outer conductor, the outer conductor including a bottom surface facing a board surface of a circuit board, a pull-out opening open in the bottom surface, the inner conductor being pulled out toward the circuit board through the pull-out opening, a mounting portion provided to project on the board surface, and board installing portions, at least one board installing portion being provided to project on each of both sides across a mounting area on the bottom surface, the mounting portion and the pull-out opening being formed in the mounting area, tip surfaces of the board installing portions being located further than a tip surface of the mounting portion.

According to the above configuration, a gap can be formed between the tip surface of the mounting portion and the board surface of the circuit board with the tip surfaces of the board installing portions supported on the board surface of the circuit board. Thus, even if the mounting portion is shifted in position with respect to the circuit board during reflow soldering, solder can follow the mounting portion and a solder fillet can be formed between the board surface of the circuit board and the mounting portion. Particularly, since at least one board installing portion is provided to project on each of the both sides across the mounting area on the bottom surface of the outer conductor, the gap formed between the tip surface of the mounting portion and the board surface of the circuit board can be kept to a proper size.

(2) Preferably, in the connector of (1) described above, the outer conductor includes a base portion and a tube portion projecting forward from the base portion, the bottom surface is arranged between the base portion and the board surface, and at least one board installing portion is provided to project on each of both front and rear sides across the mounting area.

A center of gravity of the outer conductor is located on the front side by the tube portion projecting forward from the base portion. Then, the mounting portion may be inclined with respect to the board surface of the circuit board. However, since the board installing portion located in front of the mounting area is supported by the board surface of the circuit board according to the above configuration, the inclination of the mounting portion with respect to the circuit board can be suppressed.

(3) The connector of (2) described above may be further provided with an insulating housing for holding the outer conductor, the housing being arranged on a front side of the outer conductor, the tube portion may project inwardly of the housing, and the board installing portion located in front of the mounting area may be arranged in a range of the housing in a front-rear direction.

According to the above configuration, since the board installing portion located in front of the mounting area is supported on the board surface of the circuit board in the range of the housing in the front-rear direction, forward inclination of the outer conductor can be effectively suppressed.

(4) In the connector of any one of (1) to (3) described above, a pair of the board installing portions may be provided to project at an interval in a lateral direction on each of both front and rear sides across the mounting area.

According to the above configuration, the outer conductor is stably supported on the circuit board by the respective board installing portions, and the gap formed between the tip surface of the mounting portion and the board surface of the circuit board can be adjusted to be constant. In this way, a better solder fillet can be formed between the board surface of the circuit board and the mounting portion.

### [Details of Embodiments of Present Disclosure]

Specific examples of the present disclosure are described below with reference to the drawings. Note that the present invention is not limited to these illustrations, but is represented by claims and intended to include all changes in the scope of claims and in the meaning and scope of equivalents.

### <First Embodiment>

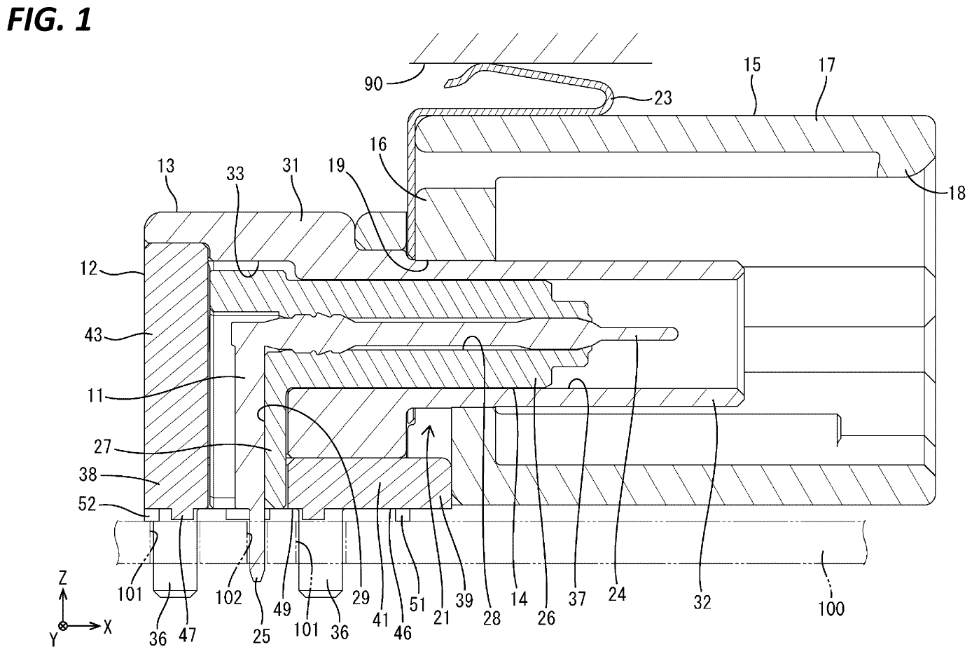

A connector 10 according to a first embodiment is illustrated as a shield connector to be mounted on a circuit board 10 as shown in FIG. 1. The connector 10 is provided with an electrically conductive inner conductor 11, an electrically conductive outer conductor 12, 13 surrounding the outer periphery of the inner conductor 11, an insulating dielectric 14 interposed between the inner conductor 11 and the outer conductor 12, 13 and an insulating housing 15 for holding the outer conductor 12, 13. The housing 15 is connectable to an unillustrated mating connector. Note that, in the following description, a side where the housing 15 is connected to the mating connector is referred to as a front side concerning a front-rear direction. An arrow X of FIG. 1 indicates the front side. A lateral direction is based on a thickness direction through the plane of FIG. 1. The lateral direction is synonymous with a width direction. Y of FIG. 1 indicates a right side. A vertical direction is based on a vertical direction of FIG. 1. The vertical direction is synonymous with a height direction. An arrow Z of FIG. 1 indicates an upper side. These direction references are for convenience. For example, a lower side does not necessarily coincide with a lower side in a gravity direction with the connector 10 installed in an unillustrated vehicle or the like.

### (Housing 15)

The housing 15 is made of synthetic resin and includes, as shown in FIG. 1, an end wall portion 16 and a receptacle 17 projecting forward from the end wall portion 16. The unillustrated mating connector is fit into the receptacle 17. The receptacle 17 includes a lock portion 18 for locking the mating connector in a connected state. The lock portion 18 is claw-like and projects inward from the upper wall of the receptacle 17. The end wall portion 16 includes an insertion hole 19 penetrating in the front-rear direction. A tube portion 32 to be described later is inserted into the insertion hole 19.

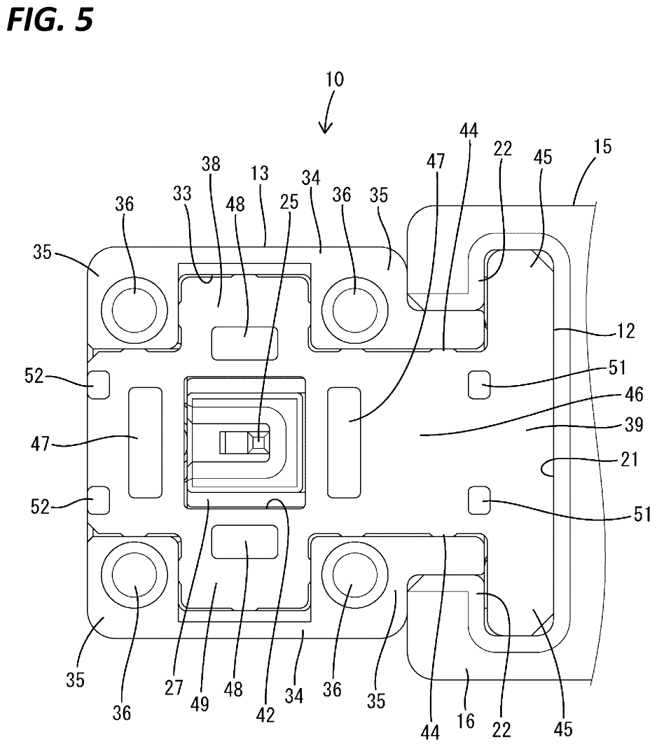

The housing 15 includes an assembly recess 21 within a wall thickness of the end wall portion 16. As shown in FIG. 5, the assembly recess 21 is open in the rear and lower surfaces of the end wall portion 16. A pair of locking portions 22 for partially closing left and right end parts of the rear surface of the assembly recess 21 are provided on a lower end side of the end wall portion 16. A later-described coupling portion 39 of the outer conductor 12 is inserted into the assembly recess 21 from below. The respective locking portions 22 are pressed into contact with left and right end parts of the coupling portion 39 from behind and the coupling portion 39 is held in the assembly recess 21.

As shown in FIG. 1, an electrically conductive connecting member 23 is mounted into the housing 15. A part of the connecting member 23 projecting upward is brought into contact with the wall surface of an electrically conductive enclosure 90 arranged outside with the connecting member 23 mounted in the housing 15. Further, a part of the connecting member 23 located inside the housing 15 with the connecting member 23 mounted in the housing 15 is brought into contact with the tube portion 32.

### (Inner Conductor 11, Dielectric 14)

The inner conductor 11 is arranged inside the outer conductor 12, 13. The inner conductor 11 is made of metal and in the form of a tab or a pin and includes, as shown in FIG. 1, a mating connecting portion 24 extending long in the front-rear direction and a board connecting portion 25 extending downward from the rear end of the mating connecting portion 24. A front end part of the mating connecting portion 24 is electrically connected to an unillustrated mating inner conductor when the housing 15 and the mating connector are connected. A lower end part of the board connecting portion 25 is inserted into a through-hole 102 of the circuit board 100 and electrically connected to a signal electrically conductive path of a circuit board 100 when the board connecting portion 25 is mounted on the circuit board 100.

The dielectric 14 is made of synthetic resin and includes, as shown in FIG. 1, a terminal accommodating portion 26 extending long in the front-rear direction and a terminal lead-out portion 27 extending downward from the rear end of the terminal accommodating portion 26. The dielectric 14 includes an accommodation chamber 28 extending in the front-rear direction in the terminal accommodating portion 26 and a lead-out groove 29 extending in the vertical direction in the terminal lead-out portion 27. The accommodation chamber 28 penetrates through the dielectric 14 in the front-rear direction. The upper end of the lead-out groove 29 communicates with the rear end of the accommodation chamber 28. The lower end of the lead-out groove 29 is open in the lower surface of the terminal lead-out portion 27. The lead-out groove 29 is open behind the terminal lead-out portion 27. The mating connecting portion 24 of the inner conductor 11 is inserted into the accommodation chamber 28 of the terminal accommodating portion 26 from behind. The mating connecting portion 24 is accommodated into the accommodation chamber 28 and the board connecting portion 25 of the inner conductor 11 contacts the back surface of the lead-out groove 29, whereby any further insertion of the inner conductor 11 is restricted. At this time, a front end part of the mating connecting portion 24 is arranged to project forward from the terminal accommodating portion 26. A lower end part of the board connecting portion 25 is arranged to project downward from the terminal lead-out portion 27. A space behind the board connecting portion 25 is closed by a back wall 43 to be described later.

### (Outer Conductor 12, 13)

The outer conductor 12, 13 is for electrically shielding the inner conductor 11 and, for example, configured as an electrically conductive die-cast rigid body. In the case of the first embodiment, the outer conductor is composed of a first outer conductor 12 and a second outer conductor 13 separate from each other. As shown in FIG. 1, the first outer conductor 12 is arranged below the second outer conductor 13.

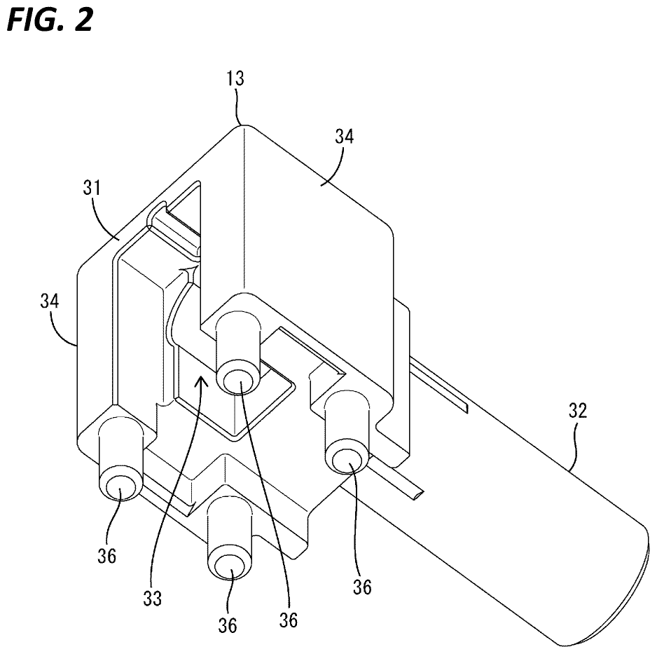

As shown in FIG. 2, the second outer conductor 13 includes a base portion 31 and the tube portion 32 projecting forward from the base portion 31. The base portion 31 is in the form of a rectangular frame and includes a mounting recess 33 inside. The mounting recess 33 is open in the rear and lower surfaces of the base portion 31. The first outer conductor 12 is inserted and mounted into the mounting recess 33 from below. The base portion 31 includes a pair of side wall portions 34 for closing left and right end parts of the mounting recess 33. As shown in FIG. 5, a lower end part of each side wall portion 34 includes supporting end parts 35 wider than an intermediate part in the front-rear direction in end parts in the front-rear direction. The respective supporting end parts 35 constitute four corner parts of the lower surface of the base portion 31. The base portion 31 includes four leg portions 36 projecting from the flat lower surfaces of the respective supporting end parts 35. Each leg portion 36 has a cylindrical shape and is, as shown in FIG. 1, inserted into each fixing hole 101 formed in the circuit board 100 and soldered and fixed to the circuit board 100.

The tube portion 32 has a hollow cylindrical shape and projects from the front surface of the base portion 31. A dimension in the front-rear direction (projecting dimension) of the tube portion 32 is larger than a length in the front-rear direction of the base portion 31. As shown in FIG. 1, the inside of the tube portion 32 serves as an insertion hole 37, into which the dielectric 14 is insertable. The insertion hole 37 is formed from the tube portion 32 to the base portion 31 and is open to the rear of the second outer conductor 13 via the mounting recess 33. In short, the insertion hole 37 penetrates through the second outer conductor 13 in the front-rear direction.

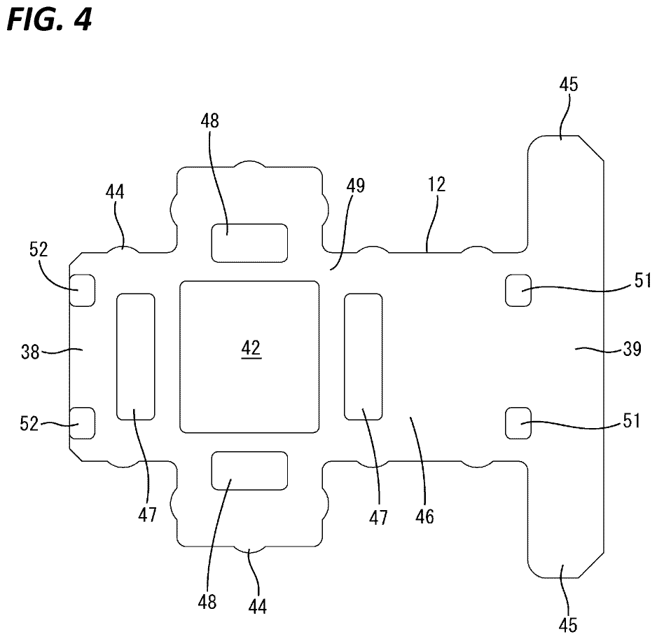

The first outer conductor 12 is composed of a body portion 38 and a coupling portion 39 connected in front of the body portion 38. As shown in FIG. 4, the body portion 38 has an outer shape corresponding to the opening shape of the mounting recess 33 of the first outer conductor 12 in a bottom view. The coupling portion 39 has an outer shape corresponding to the opening shape of the assembly recess 21 of the housing 15 in the bottom view.

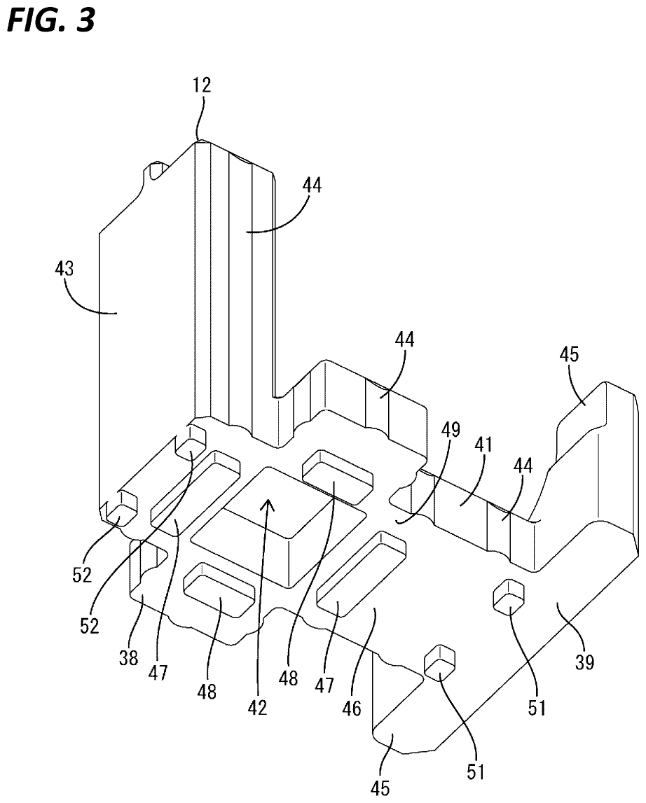

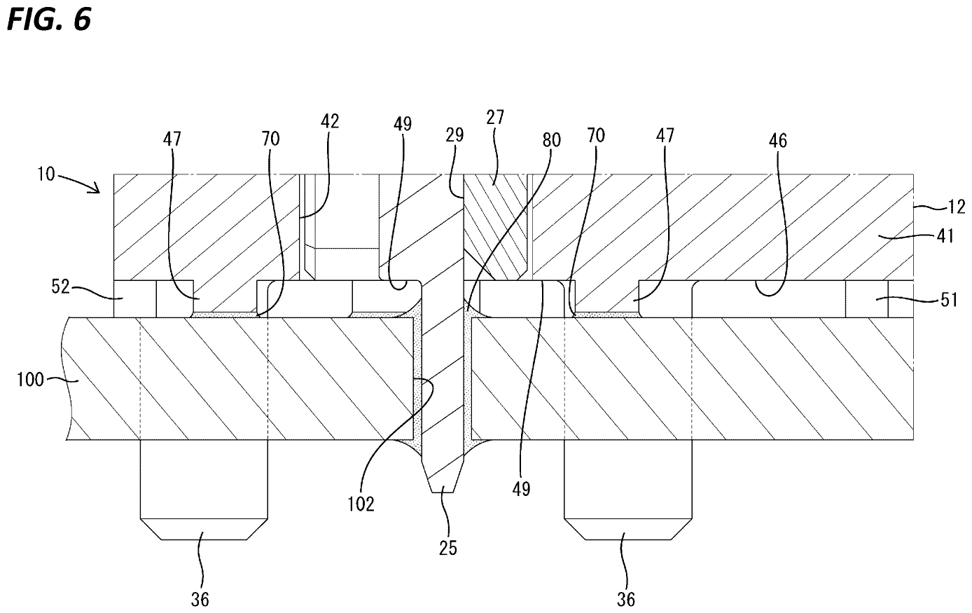

As shown in FIG. 3, the first outer conductor 12 includes a plate-like bottom wall 41 constituting bottom parts of the body portion 38 and the coupling portion 39. The body portion 38 includes a pull-out opening 42 having a rectangular bottom view shape and penetrating through a part on a rear end side of the bottom wall 41 in a thickness direction (vertical direction). As shown in FIGS. 5 and 6, a lower end part of the terminal lead-out portion 27 of the dielectric 14 is fit into the pull-out opening 42 of the bottom wall 41. A lower end part of the board connecting portion 25 of the inner conductor 11 is pulled out from the pull-out opening 42 of the bottom wall 41 and inserted into the through-hole 102 of the circuit board 100.

The body portion 38 includes the back wall 43 rising upward on a rear end side of the bottom wall 41. As shown in FIG. 1, the back wall 43 closes a rear surface opening of the mounting recess 33 of the second outer conductor 13 with the first outer conductor 12 mounted in the mounting recess 33 of the second outer conductor 13.

As shown in FIG. 3, a plurality of holding ribs 44 extending in the vertical direction are formed on the respective left and right surfaces of the back wall 43 and the bottom wall 41. As shown in FIG. 5, the respective holding ribs 44 are pressed into contact with the inner surface of the mounting recess 33, whereby the first outer conductor 12 is held in the second outer conductor 13.

As shown in FIG. 3, the coupling portion 39 includes a pair of projecting walls 45 rising upward in left and right end parts on a front end side of the bottom wall 41. As shown in FIG. 5, each projecting wall 45 is fit into the assembly recess 21 of the housing 15.

The second outer conductor 13 is assembled into the housing 15 from behind. Thereafter, the first outer conductor 12 is assembled with the second outer conductor 13 and the housing 15 to cross over these from below. The body portion 38 is press-fit into the mounting recess 33 and the coupling portion 39 is press-fit into the assembly recess 21, whereby the first outer conductor 12, the second outer conductor 13 and the housing 15 are held in an assembled state.

As shown in FIGS. 3 to 5, the lower surface of the bottom wall 41 serves as a flat bottom surface 46 extending in the front-rear direction and the lateral direction. A plurality of mounting portions 47, 48 are provided to project at intervals around the pull-out opening 42 on the bottom surface 46 of the bottom wall 41. The respective mounting portions 47, 48 are soldered and electrically connected to a ground electrically conductive path (copper foil) on the board surface of the circuit board 100. Out of the bottom surface 46 of the body portion 38, an inner area except an outer edge part serves as a mounting area 49, in which the pull-out opening 42, from which the lower end part of the board connecting portion 25 of the inner conductor 11 is pulled out, and the respective mounting portions 47, 48 are arranged and which is solder-mounted on the circuit board 100. Note that, as shown in FIG. 1, the tip of the tube portion 32 is, for example, located forward of the mounting area 49 in the front-rear direction. Further, with the connector 10 arranged on the circuit board 100, the bottom surface 46 is arranged between the base portion 31 and the board surface of the circuit board 100.

As shown in FIGS. 3 to 5, a pair of first mounting portions 47 are arranged on both front and rear sides across the pull-out opening 42. Further, a pair of second mounting portions 48 are arranged on both left and right sides across the pull-out opening 42. The respective first mounting portions 47 are in the form of ribs respectively extending in the lateral direction along the front and rear edges of the pull-out opening 42, and the tip surfaces (lower surfaces) thereof in a projecting direction are formed to be flat in the lateral direction. The respective second mounting portions 48 are in the form of ribs respectively extending in the front-rear direction along the left and right edges of the pull-out opening 42 and the tip surfaces (lower surfaces) thereof in the projecting direction are formed to be flat in the front-rear direction. A dimension in the front-rear direction (front-rear length) of each second mounting portion 48 is smaller than a dimension in the lateral direction (lateral length) of each first mounting portion 47. The tip surface of each first mounting portion 47 and that of each second mounting portion 48 are respectively arranged at the same height position. The respective supporting end parts 35 (including the respective leg portions 36) of the second outer conductor 13 are arranged at positions on both left and right sides across the respective first mounting portions 47 and on both front and rear sides across the respective second mounting portions 48.

A plurality of board installing portions 51, 52 are provided to project on both front and rear sides across the mounting area 49 on the bottom surface 46 of the bottom wall 41. Each board installing portion 51, 52 is placed on a resist on the board surface of the circuit board 100. Each board installing portion 51, 52 is in the form of a rectangular column and the tip surface (lower surface) thereof in a projecting direction is formed to be flat. A projecting dimension of each board installing portion 51, 52 from the bottom surface 46 is larger than that of each mounting portion 47, 48 from the bottom surface 46. The tip surface of each board installing portion 51, 52 is arranged below that of each mounting portion 47, 48. The tip surfaces of the respective board installing portions 51, 52 are respectively arranged at the same height position and located on the lowermost end of the first outer conductor 12. Thus, the tip surface of each board installing portion 51, 52 is located further than the tip surface of each mounting portion 47, 48 in the projecting direction of the board installing portions 51, 52. An area of the tip surface of each board installing portion 51, 52 is smaller than that of the tip surface of each mounting portion 47, 48.

The respective board installing portions include a pair of first board installing portions 51 arranged at an interval in the lateral direction at positions separated forward from the front first mounting portion 47 and a pair of second board installing portions 52 arranged at an interval in the lateral direction at positions separated rearward from the rear first mounting portion 47. Each first board installing portion 51 is provided on a front end side of the bottom surface 46 of the coupling portion 39. Each first board installing portion 51 is arranged in a range of the housing 15 in the front-rear direction by press-fitting the coupling portion 39 into the assembly recess 21. In the connector 10 of the first embodiment, since the tube portion 32 projects forward from the base portion 31 and the housing 15 is connected in front of the outer conductor 12, 13, a center of gravity is located on the side of the housing 15. Each first board installing portion 51 is stably supported on the circuit board 100 by being arranged near the center of gravity of the connector 10.

Each second board installing portion 52 is provided on a rear end side of the bottom surface 46 of the body portion 38. The rear surface of each second board installing portion 52 is continuous with the rear surface of the bottom wall 41 without any step. A separation distance in the front-rear direction between the front first mounting portion 47 and each first board installing portion 51 is longer than that between the rear first mounting portion 47 and each second board installing portion 52.

### (Functions of Connector 10)

The connector 10 is mounted on the circuit board 100 by reflow soldering. Prior to reflow soldering, the connector 10 is placed on the circuit board 100. At this time, each leg portion 36 is inserted into each fixing hole 101 and each board installing portion 51, 52 is placed on the board surface of the circuit board 100. By supporting each board installing portion 51, 52 on the circuit board 100, a fixed interval is kept between the bottom surface 46 of the bottom wall 41 and the circuit board 100. Further, at this time, the tip surface of each mounting portion 47, 48 is arranged to face the board surface across a gap formed between the board surface of the circuit board 100 and the tip surface by bringing the tip surface of each board installing portion 51, 52 into contact with the board surface of the circuit board 100 and arranging the connector 10 on the circuit board 100. For example, the tip surface of each mounting portion 47, 48 is arranged to face the board surface of the circuit board 100 in parallel.

Subsequently, the connector 10 is heated in an unillustrated reflow furnace, and solder on the board surface of the circuit board 100 is melted. In this way, as shown in FIG. 6, a solder fillet 70 is formed between the tip surface of each mounting portion 47, 48 and the board surface of the circuit board 100. Further, a solder fillet 80 is also formed between the lower end part of the board connecting portion 25 of the inner conductor 11 and the board surface of the circuit board 100. Thereafter, the solder is cooled and solidified, whereby each mounting portion 47, 48 of the outer conductor 12, 13 is soldered and connected to the ground electrically conductive path of the circuit board 100 and the board connecting portion 25 of the inner conductor 11 is soldered and connected to the signal electrically conductive path of the circuit board 100. Out of the lower end part of the board connecting portion 25 of the inner conductor 11, a part exposed between the bottom surface 46 of the bottom wall 41 and the board surface of the circuit board 100 is surrounded on four sides (in the front-rear direction and the lateral direction) by the respective mounting portions 47, 48. In this way, shielding performance for the inner conductor 11 is enhanced. Further, each leg portion 36 is soldered and fixed to each fixing hole 101 of the circuit board 100.

Soldering is not applied to each board installing portion 51, 52 and each board installing portion 51, 52 fulfills a function of keeping an interval between the bottom surface 46 of the bottom wall 41 and the board surface of the circuit board 100 constant during a reflow soldering step. Thus, even if the connector 10 is shifted in position with respect to the circuit board 100, it can be avoided that each mounting portion 47, 48 contacts the resist.

Each board installing portion 51, 52 fulfills the aforementioned interval keeping function, whereby a gap is formed between the tip surface of each mounting portion 47, 48 and the board surface of the circuit board 100. Thus, the solder in a molten state can follow a position shift direction of each mounting portion 47, 48 and properly form the solder fillet 70.

As described above, according to the first embodiment, the gap can be formed between the tip surface of each mounting portion 47, 48 and the board surface of the circuit board 100 with the tip surface of each board installing portion 51, 52 supported on the board surface of the circuit board 100. Thus, even if each mounting portion 47, 48 is shifted in position with respect to the circuit board 100 during reflow soldering, the solder can follow each mounting portion 47, 48 and the solder fillet 70 can be properly formed between the board surface of the circuit board 100 and each mounting portion 47, 48. Particularly, since the pair of board installing portions 51 and the pair of board installing portions 52 are provided to project on both sides across the mounting area 49 on the bottom surface 46 of the first outer conductor 12, the gap formed between the tip surface of each mounting portion 47, 48 and the board surface of the circuit board 100 can be adjusted to a constant proper size. As a result, the mountability of the connector 10 can be improved.

Further, in the case of the first embodiment, since each first board installing portion 51 located forward of the mounting area 49 is supported on the board surface of the circuit board 100 near the center of gravity position of the connector 10, the inclination of each mounting portion 47, 48 with respect to the circuit board 100 during reflow soldering can be suppressed.

### <Second Embodiment>

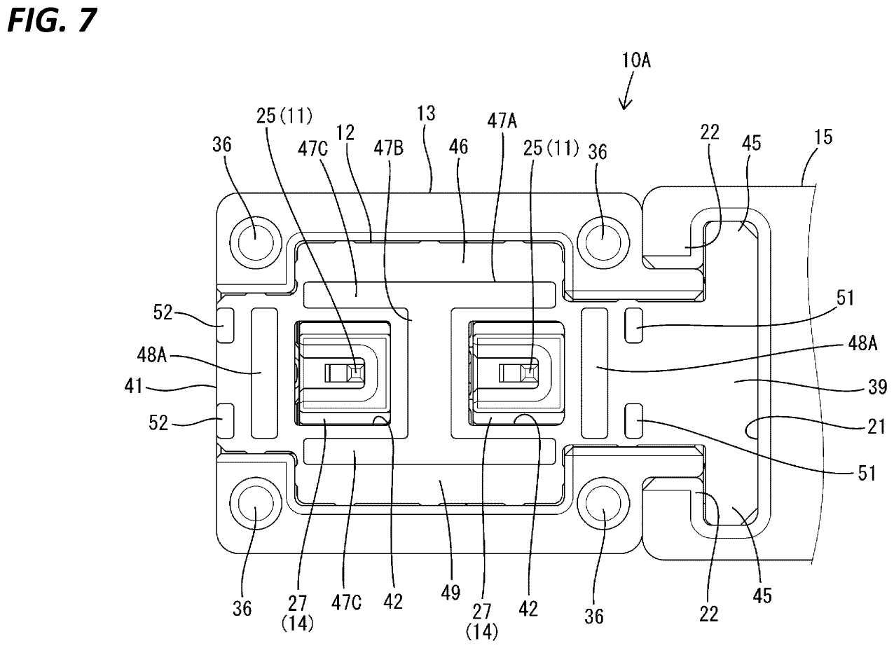

A connector 10A according to a second embodiment differs from the first embodiment in that, as shown in FIG. 7, two inner conductors 11 and two dielectrics 14 are provided, two pull-out openings 42 are open in a bottom surface 46 of a bottom wall 41 and a plurality of mounting portions 47A, 48A are provided to correspond to the respective pull-out openings 42. The other configuration is the same as in the first embodiment, and structures identical or similar to those of the first embodiment are denoted by the same reference signs and repeated description is omitted in the second embodiment.

As shown in FIG. 7, the two pull-out openings 42 are provided side by side in the front-rear direction in the bottom wall 41 of a first outer conductor 12. Each pull-out opening 42 is open to have a rectangular bottom view shape in the bottom surface 46 of the bottom wall 41. The rear edge of the front pull-out opening 42 and the front edge of the rear pull-out opening 42 are arranged in parallel to each other. Lower end parts of terminal lead-out portions 27 of the two dielectrics 14 are respectively fit into the corresponding pull-out openings 42. The lower end part of the board connecting portion 25 of each of the two inner conductors 11 projects downward from the corresponding pull-out opening 42.

The plurality of mounting portions include a main mounting portion 47A arranged in a part except end parts in the front-rear direction in a mounting area 49 and a pair of sub-mounting portions 48A arranged in the end parts in the front-rear direction of the mounting area 49. The main mounting portion 47A is composed of a rib-like intermediate mounting portion 47B extending in the lateral direction between the respective pull-out openings 42 and a pair of rib-like side mounting portions 47C extending long over the respective pull-out openings 42 along the respective left and right edges of the respective pull-out openings 42. End parts in the lateral direction of the intermediate mounting portion 47B are respectively coupled to intermediate parts in the front-rear direction of the respective side mounting portions 47C. A dimension in the front-rear direction (front-rear width) of the intermediate mounting portion 47B is larger than a dimension in the lateral direction (lateral width) of the side mounting portion 47C. The main mounting portion 47A is H-shaped in a bottom view by including the intermediate mounting portion 47B and the respective side mounting portions 47C. The tip surface of the main mounting portion 47A is formed to be flat along the H shape of the main mounting portion 47A.

The respective sub-mounting portions 48A are constituted by a rib-like part extending in the lateral direction along the front edge of the front pull-out opening 42 and a rib-like part extending in the lateral direction along the rear edge of the rear pull-out opening 42. The tip surface of each sub-mounting portion 48A is formed to be flat at the same height position as the tip surface of the main mounting portion 47A. A dimension in the front-rear direction of each sub-mounting portion 48A is smaller than that of the intermediate mounting portion 47B.

A pair of board installing portions 51 and a pair of board installing portions 52 are provided to project at an interval in the lateral direction on both front and rear sides across the mounting area 49. The tip surface of each board installing portion 51, 52 is arranged below that of each mounting portion 47A, 48A. Each board installing portion 51, 52 is placed on a board surface of a circuit board 100. A gap is formed between each mounting portion 47A, 48A and the board surface of the circuit board 100 by each board installing portion 51, 52. The structures and arrangement of the board installing portions 51, 52 are similar to those of the first embodiment.

According to the second embodiment, since the main mounting portion 47A and the respective sub-mounting portions 48A surround the respective pull-out openings 42 on four sides, shielding performance for the respective inner conductors 11 pulled out from the respective pull-out openings 42 can be enhanced. Particularly, since the intermediate mounting portion 47B of the main mounting portion 47A is provided between the board connecting portions 25 of the respective inner conductors 11, a crosstalk between the respective inner conductors 11 can be prevented.

### [Other Embodiments of Present Disclosure]

The first and second embodiments disclosed this time should be considered illustrative in all aspects, rather than restrictive.

In the case of the first and second embodiments, the pair of board connecting portions are arranged on each of the both sides across the mounting area. In contrast, according to another embodiment, one board connecting portion may be arranged on each of the both sides across the mounting area or three or more board connecting portions may be arranged on each of the both sides across the mounting area.

In the case of the first and second embodiments, the board connecting portions are arranged on the both front and rear sides across the mounting area. In contrast, according to another embodiment, board connecting portions may be arranged on both left and right sides across the mounting area. Further, board connecting portions may be arranged on the both front and rear sides and on the both left and right sides across the mounting area.

In the case of the first and second embodiments, the plurality of mounting portions are arranged around the pull-out opening on the bottom surface of the bottom wall. In contrast, according to another embodiment, one mounting portion may be arranged to surround the pull-out opening over the entire periphery on the bottom surface of the bottom wall.

In the case of the first and second embodiments, the mounting portion is shaped to extend straight along the opening edge of the pull-out opening on the bottom surface of the bottom wall. In contrast, if the pull-out opening has, for example, a circular opening shape, the mounting portion may be shaped to be curved and extend along the opening edge of the pull-out opening.

In the case of the first and second embodiments, the outer conductor can be separated into the first and second outer conductors and the first and second outer conductors can be united into the outer conductor. In contrast, according to another embodiment, an outer conductor may be an inseparable integrated outer conductor.

In the case of the first and second embodiments, the outer conductor is made of die casting. In contrast, according to another embodiment, an outer conductor may be formed by cutting a block member made of metal.

### LIST OF REFERENCE NUMERALS

10, 10A . . . connector
11 . . . inner conductor
12 . . . first outer conductor (outer conductor)
13 . . . second outer conductor (outer conductor)
14 . . . dielectric
15 . . . housing
16 . . . end wall portion
17 . . . receptacle
18 . . . lock portion
19 . . . insertion hole
21 . . . assembly recess
22 . . . locking portion
23 . . . connecting member
24 . . . mating connecting portion
25 . . . board connecting portion
26 . . . terminal connecting portion
27 . . . terminal lead-out portion
28 . . . accommodation chamber
29 . . . lead-out groove
31 . . . base portion
32 . . . tube portion
33 . . . mounting recess
34 . . . side wall portion
35 . . . supporting end part
36 . . . leg portion
37 . . . insertion hole
38 . . . body portion
39 . . . coupling portion
41 . . . bottom wall
42 . . . pull-out opening
43 . . . back wall
44 . . . holding rib
45 . . . projecting wall
46 . . . bottom surface
47 . . . first mounting portion (mounting portion)
47A . . . main mounting portion (mounting portion)
47B . . . intermediate mounting portion (mounting portion)
47C . . . side mounting portion (mounting portion)
48 . . . second mounting portion (mounting portion)
48A . . . sub-mounting portion (mounting portion)
49 . . . mounting area
51 . . . first board installing portion (board installing portion)
52 . . . second board installing portion (board installing portion)
70 . . . solder fillet (on mounting portion side)
80 . . . solder fillet (on inner conductor side)
90 . . . enclosure
100 . . . circuit board
101 . . . fixing hole
102 . . . through-hole

1. A connector, comprising:
an electrically conductive outer conductor;
an electrically conductive inner conductor to be arranged inside the outer conductor; and
an insulating dielectric interposed between the inner conductor and the outer conductor, the outer conductor including:
a bottom surface facing a board surface of a circuit board;
a pull-out opening open in the bottom surface, the inner conductor being pulled out toward the circuit board through the pull-out opening;
a mounting portion provided to project on the board surface; and
board installing portions, at least one board installing portion being provided to project on each of both sides across a mounting area on the bottom surface, the mounting portion and the pull-out opening being formed in the mounting area, tip surfaces of the board installing portions being located further than a tip surface of the mounting portion.

212. The connector of claim 1, wherein:
the outer conductor includes a base portion and a tube portion projecting forward from the base portion,
the bottom surface is arranged between the base portion and the board surface, and
at least one board installing portion is provided to project on each of both front and rear sides across the mounting area.

3. The connector of claim 2, further comprising an insulating housing for holding the outer conductor, the housing being arranged on a front side of the outer conductor, wherein:
the tube portion projects inwardly of the housing, and
the board installing portion located in front of the mounting area is arranged in a range of the housing in a front-rear direction.

4. The connector of claim 1, wherein a pair of the board installing portions are provided to project at an interval in a lateral direction on each of both front and rear sides across the mounting area.
